(19) United States
(12) Patent Application Publication
(10) Pub. No.: US 2025/0377465 A1
(43) Pub. Date: Dec. 11, 2025

(54) BINARY OFFSET CARRIER PSEUDO RANDOM NOISE SIGNAL TRACKING

(71) Applicant: The Boeing Company, Arlington, VA (US)

(72) Inventor: Isaac Jeng, Los Angeles, CA (US)

(21) Appl. No.: 18/735,837

(22) Filed: Jun. 6, 2024

(51) Int. Cl. G01S 19/30

(52) U.S. Cl. CPC G01S 19/30

(57) ABSTRACT

A method for tracking a binary offset carrier (BOC) pseudo random noise (PRN) signal is disclosed. A BOC PRN signal is received from a satellite. A BOC PRN correlation between the BOC PRN signal and a local replica of the BOC PRN signal is formed. A center peak is extracted from the BOC PRN correlation. A center peak local replica signal is generated based on the center peak extracted from the BOC PRN correlation. A center peak correlation between the BOC PRN signal and the center peak local replica signal is formed. Navigation data for the satellite is retrieved from the BOC PRN signal based at least on the center peak correlation meeting steady tracking criteria.

### FIELD

The present disclosure relates to signal processing and, more specifically, to acquiring and tracking signals received from satellites.

### BACKGROUND

A Pseudo Random Noise (PRN) signal is a specific type of signal used in satellite navigation systems like GPS (Global Positioning System) to enable precise ranging and positioning. PRN signals are generated using pseudorandom noise sequences, which are deterministic sequences of digital codes that exhibit properties similar to random noise. Each satellite in a GPS constellation broadcasts a unique PRN code sequence from that satellite to all receivers that receive this satellite's transmission. These codes are carefully designed to be orthogonal or nearly orthogonal to each other to minimize interference and enable accurate signal acquisition and processing. The PRN signal includes a PRN code sequence and navigation data.

For transmission, the PRN signal can be modulated onto a subcarrier signal using a binary offset carrier (BOC) modulation scheme to generate a BOC PRN signal that is a combination of a BOC-modulated carrier signal and a PRN code sequence unique to each satellite. More particularly, the BOC PRN signal combines two frequency components (usually referred to as sub-carriers) with a specific offset or phase relationship. Typically, the BOC modulation is represented as BOC (m,n), where ‘m’ and ‘n’ are integers defining the ratio of the main carrier frequency and the offset carrier frequency. For example, common BOC signals include BOC (1,1), BOC (6,1), etc. The purpose of separating the main lobe of the associated PRN signal into two offset lobes via BOC modulation is to keep the two main lobes away from being jammed around the carrier. If jamming at the carrier occurs, a PRN signal having a main lobe centered at the carrier will end up with many more errors, compared to that of the BOC PRN signal. BOC PRN signals offer enhanced signal robustness and increased resistance to interference compared to conventional navigation signals.

### SUMMARY

A method for tracking a binary offset carrier (BOC) pseudo random noise (PRN) signal that is performed by a satellite receiver is disclosed. A BOC PRN signal is received from a satellite. A BOC PRN correlation between the BOC PRN signal received from the satellite and a local replica of the BOC PRN signal is formed. A center peak is extracted from the BOC PRN correlation. A center peak local replica signal is generated based at least on the center peak extracted from the BOC PRN correlation. A center peak correlation between the BOC PRN signal received from the satellite and the center peak local replica signal is formed. Navigation data for the satellite is retrieved from the BOC PRN signal based at least on the center peak correlation meeting steady tracking criteria.

The features and functions that have been discussed can be achieved independently in various embodiments or can be combined in yet other embodiments, further details of which can be seen with reference to the following description and drawings.

### BRIEF DESCRIPTION OF THE DRAWINGS

FIG. 1 shows an example satellite receiver configured to acquire and track binary offset carrier (BOC) pseudo random noise (PRN) signals of a plurality of satellites, according to one embodiment of the present disclosure.

FIG. 2 schematically shows a block diagram of the satellite receiver shown in FIG. 1.

FIG. 3 shows a graph of an example BOC PRN signal represented in a frequency domain.

FIG. 4 shows a graph of an example BOC PRN signal represented in a time domain.

FIG. 5 shows a graph of different correlations between a BOC PRN signal and different local replicas.

FIGS. 6A-6B show an example method performed by a satellite receiver to track a BOC PRN signal with improved accuracy relative to a conventional tracking approach.

FIG. 7 shows an example computing system.

### DETAILED DESCRIPTION

A binary offset carrier (BOC) pseudo random noise (PRN) signal can be transmitted by a satellite to a satellite receiver for satellite navigation tracking purposes. According to a conventional tracking approach, when a satellite receiver receives a BOC PRN signal from a satellite, the satellite forms a correlation between the BOC PRN signal received from the satellite and a known local replica of the BOC PRN signal stored in memory of the satellite receiver. The satellite receiver uses the correlation as feedback to adjust characteristics of the local replica of the BOC PRN signal to achieve steady tracking of the BOC PRN signal received from the satellite. Such steady tracking allows for the satellite receiver to retrieve navigation data from the BOC PRN signal. The satellite receiver can use the navigation data retrieved from the BOC PRN signal along with navigation data retrieved from a plurality of other BOC PRN signals received from a plurality of other satellites to calculate a position of the satellite receiver, among other navigation information.

However, unlike a PRN signal that is not modulated using a BOC modulation scheme and whose correlation has only one main peak, the binary offset subcarrier in a BOC PRN signal produces a correlation that has multiple peaks. When the BOC PRN correlation is formed using the conventional approach discussed above, these multiple peaks cause tracking ambiguities that limit the accuracy to which the BOC PRN signal can be tracked. More particularly, the multiple peaks of the correlation formed according to the conventional approach can lead to ambiguity in identifying the correct signal peak to track. Additionally, additive noise in a received BOC PRN signal further deteriorates tracking accuracy when using the conventional approach.

Accordingly, examples are disclosed that relate to tracking a BOC PRN signal in a manner that increases tracking accuracy relative to a conventional tracking approach. In one example, a BOC PRN signal is received from a satellite. A correlation between the BOC PRN signal received from the satellite and a local replica of the BOC PRN signal is formed. A center peak is extracted from the correlation between the BOC PRN signal and the local replica of the BOC PRN signal. A center peak local replica signal is generated based at least on the center peak extracted from the correlation between the BOC PRN signal and the local replica of the BOC PRN signal. A correlation between the BOC PRN signal received from the satellite and the center peak local replica signal is formed. Navigation data for the satellite is retrieved from the BOC PRN signal based at least on the correlation between the BOC PRN signal and the center peak local replica signal meeting steady tracking criteria.

By extracting the center peak from the initial correlation between the BOC PRN signal and the local replica of the BOC PRN signal to generate a center peak local replica signal and forming a more refined correlation between the BOC PRN signal and the center peak local replica signal, any ambiguity due to having multiple peaks is eliminated. That is, the single center peak of the center peak local replica signal forms a correlation with the BOC PRN signal that has tighter tracking tolerances relative to the correlation formed from the local replica of the BOC PRN signal that has multiple peaks. In this way, the BOC PRN signal can be tracked using the center peak local replica signal with reduced tracking error relative to the conventional approach that uses the local replica of the BOC PRN signal.

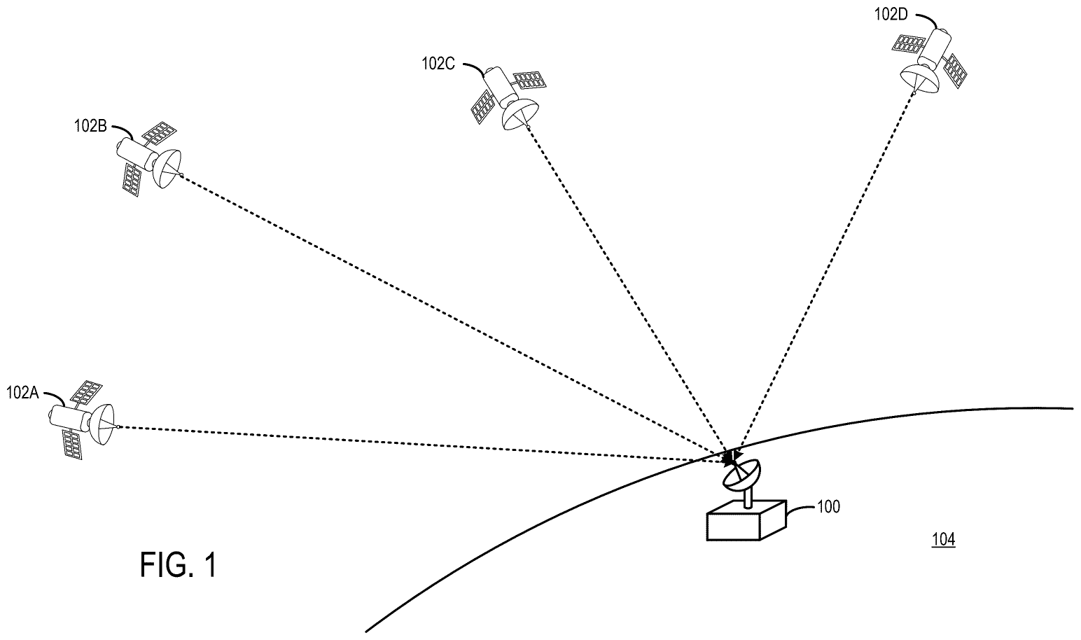

FIG. 1 shows an example satellite receiver 100 that is configured to acquire, track, and process BOC PRN signals received from a plurality of satellites 102A, 102B, 102C, 102D in a manner that increases tracking accuracy relative to a conventional tracking approach as described herein. The satellite receiver 100 can take any suitable form of device that can acquire then track a BOC PRN signal from a satellite. In some examples, the satellite receiver 100 has a fixed location on the Earth 104. In other examples, the satellite receiver 100 is movable. For example, the satellite receiver 100 can be integrated into a vehicle or a mobile device. The satellite receiver 100 can be employed across diverse applications including navigation, communication, broadcasting, remote sensing, scientific research, and defense.

The satellite receiver 100 is located on a celestial body in the form of the planet Earth 104, in this example. In some examples, the plurality of satellites 102A, 102B, 102C, 102D can be included in a constellation of satellites strategically positioned in orbit around the Earth 104 based on mission requirements and operational objectives in order to achieve coverage of a specific region (or achieve global coverage). As the plurality of satellites orbit the Earth 104, each of the plurality of satellites 102A, 102B, 102C, 102D broadcasts a unique BOC PRN signal that includes a PRN code sequence and navigation data that are collectively modulated with a BOC modulation scheme.

When one of the plurality of satellites 102A, 102B, 102C, 102D, such as the satellite 102A, comes within view of the satellite receiver 100, the satellite receiver 100 receives the BOC PRN signal from the satellite 102A. The satellite receiver 100 forms a correlation between the BOC PRN signal received from the satellite 102A and a known local replica of the BOC PRN signal that is stored in memory of the satellite receiver 100. Further, the satellite receiver 100 extracts a center peak from the correlation between the BOC PRN signal and the local replica of the BOC PRN signal. The satellite receiver 100 generates a center peak local replica signal based at least on the center peak extracted from the correlation between the BOC PRN signal and the local replica of the BOC PRN signal. The satellite receiver 100 forms a correlation between the BOC PRN signal received from the satellite 102A and the center peak local replica signal.

Furthermore, the satellite receiver 100 determines if the correlation between the BOC PRN signal and the center peak local replica signal meet steady tracking criteria. The steady tracking criteria is used to determine if conditions are suitable for the satellite receiver 100 to accurately retrieve the navigation data from the BOC PRN signal received from the satellite 102A. In one example, the steady tracking criteria includes comparing the correlation to a threshold. If the correlation exceeds the threshold, then the steady tracking criteria is met, and the time offset and frequency offset of the local replica are used to track the BOC PRN signal. The satellite receiver 100 can adjust the time offset and frequency offset as needed to continue to meet the steady tracking criteria. Otherwise, if the correlation does not exceed the threshold, then the satellite receiver 100 adjusts at least one of the time offset and the frequency offset of the center peak local replica based at least on a hypothesis for the correlation, and iterates searching, matching, and thresholding again to try to meet the steady tracking criteria. Further, based at least on the correlation between the BOC PRN signal and the center peak local replica signal meeting the steady tracking criteria, the satellite receiver 100 retrieves navigation data for the satellite from the BOC PRN signal.

By tracking a BOC PRN signal received from a satellite based at least on a correlation between the BOC PRN signal received from the satellite and the center peak local replica signal generated for the BOC PRN signal, ambiguity and tracking errors are reduced relative to a conventional tracking approach. This is because the center peak local replica signal only includes the center peak of the initial correlation and the other side-peaks generated from the BOC modulation scheme are not generated by the center peak local replica signal.

The satellite receiver 100 tracks corresponding BOC PRN signals received from each of the plurality of satellites 102B, 102C, 102D in the same manner using the above-described approach. Further, the satellite receiver 100 calculates a navigation solution for the satellite receiver 100 based at least on the navigation data retrieved from the corresponding BOC PRN signals received from the plurality of satellites. In some examples, the navigation solution includes a position, velocity, timing (PVT) solution that is the calculation of a position, velocity (speed and direction), and precise timing of the satellite receiver 100 using the navigation data retrieved from the corresponding BOC PRN signals received from each of the plurality of satellites 102B, 102C, 102D.

The high-precision BOC PRN signal tracking approach employed by the satellite receiver 100 can be used to track BOC PRN signals from one constellation of satellites or multiple constellations of satellites. In addition, the high-precision BOC PRN signal tracking approach can be employed in various other applications, such as precision guided munitions, rapid suborbital cargo delivery through space, autonomous reentry capsules, reusable manned spacecraft, reusable unmanned space vehicles, reusable launch vehicles, all unmanned spacecraft from low-earth orbit (LEO) to geosynchronous equatorial orbit (GEO), all unmanned spacecraft to CisLunar (i.e., space between the Earth and the Moon), autonomous orbit transfer and space resupply vehicles, autonomous refueling platforms, fully autonomous passenger aircraft, etc.

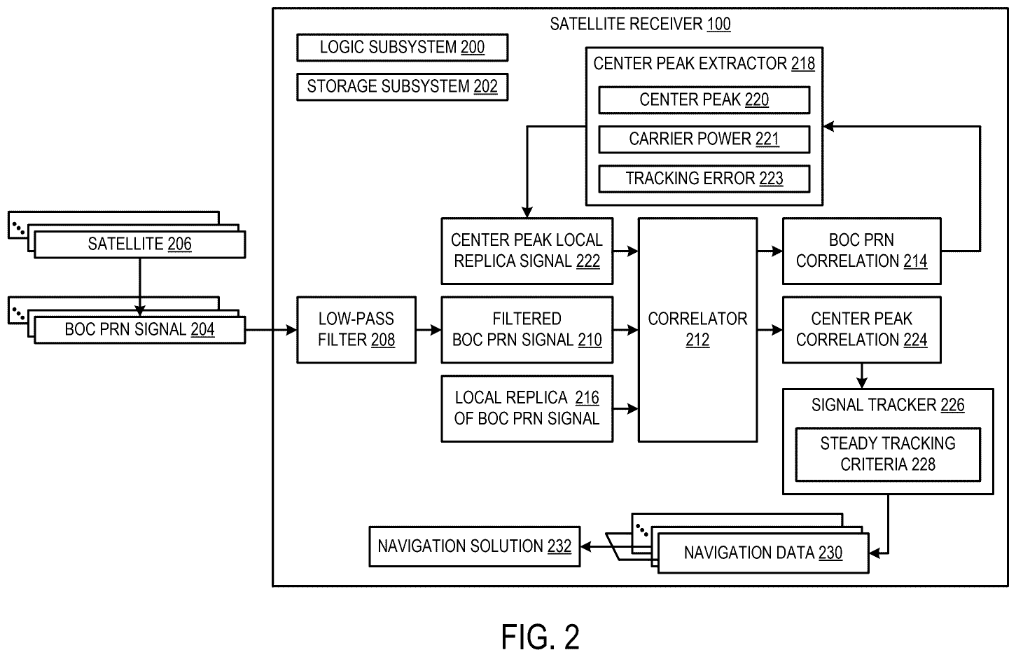

FIG. 2 schematically shows a block diagram of the satellite receiver 100 shown in FIG. 1. The satellite receiver 100 comprises a logic subsystem 200 and a storage subsystem 202 holding instructions executable by the logic subsystem 200 to execute computing operations to control a state of the satellite receiver 100. More particularly, the storage subsystem 202 holds instructions executable by the logic subsystem 200 to acquire, track, and process BOC PRN signals received from a plurality of satellites (e.g., satellites 102A, 102B, 102C, 102D shown in FIG. 1) in a manner that increases tracking accuracy relative to a conventional tracking approach.

The storage subsystem 202 holds instructions executable by the logic subsystem 200 to receive a BOC PRN signal 204 from a satellite 206. For example, the satellite 206 can be representative of any of the plurality of satellites 102A, 102B, 102C, 102D shown in FIG. 1.

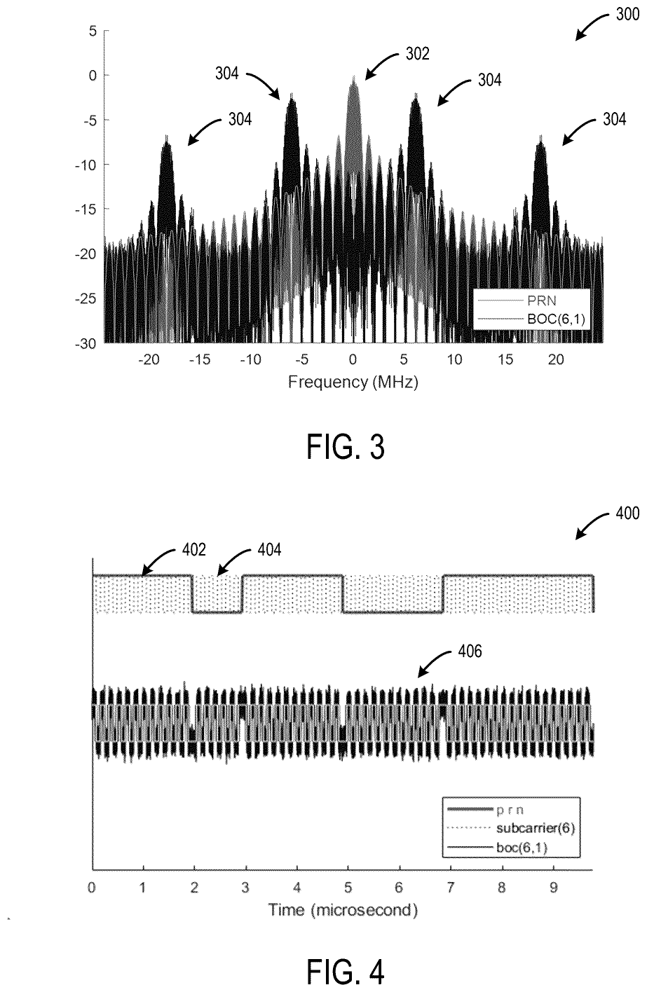

FIG. 3 shows a graph of an example BOC PRN signal 300 represented in a frequency domain. In the illustrated example, the BOC PRN signal 300 has a BOC of (6,1), where the first value (6) is the binary offset carrier frequency, and the second value (1) is the chipping rate of the associated PRN. The chipping rate of the associated PRN refers to the number of chips or pulses per unit time of the BOC PRN signal 300. The BOC PRN signal includes a PRN component and a BOC component. The PRN component of the BOC PRN signal 300 is indicated by a light-colored line and the BOC component of the BOC PRN signal 300 is indicated by a dark-colored line. The BOC PRN signal 300 includes a PRN main peak 302 centered at a transmission carrier of the BOC PRN signal 300, which is located at 0 Hz frequency, in this example. The BOC PRN signal 300 further includes a plurality of binary offset carrier peaks 304 that are frequency-shifted relative to the associated PRN peak 302. The purpose of separating the main peak 302 of the associated PRN into the plurality of binary offset carrier peaks 304 is to keep the plurality of binary offset peaks 304 away from being jammed around the PRN main peak 302 at the transmission carrier.

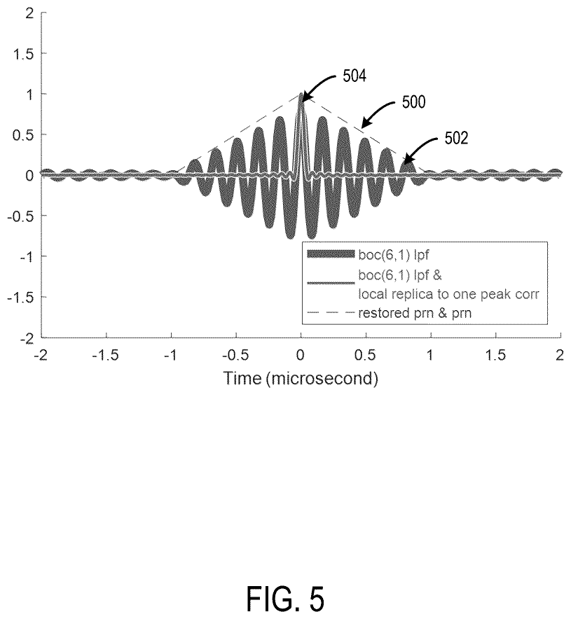

FIG. 4 shows a graph of a BOC PRN signal 400 represented in a time domain that corresponds to the BOC PRN signal 300 shown in FIG. 3. The BOC PRN signal 400 includes a PRN component 402 (thick solid line), a subcarrier component 404 (dotted line), and a BOC component 406 (thin solid line in light color).

Returning to FIG. 2, in some embodiments, the satellite receiver 100 includes a low-pass filter 208 that is configured to filter the BOC PRN signal 204 received from the satellite 206 to generate a filtered BOC PRN signal 210. The low-pass filter 208 is configured to filter out signal noise from the BOC PRN signal 204 to increase the SNR of the filtered BOC PRN signal 210. In some examples, the low-pass filter 208 is implemented as a physical hardware device. In other examples, the low-pass filter 208 is implemented as a software program.

The storage subsystem 202 holds instructions executable by the logic subsystem 200 to instantiate a correlator 212. The correlator 212 is configured to form a BOC PRN correlation 214 between the BOC PRN signal 204 received from the satellite 206 and a local replica 216 of the BOC PRN signal that is stored in the storage subsystem 202. The local replica 216 of the BOC PRN signal is an analytical copy of the BOC PRN signal 204. The local replica 216 of the BOC PRN signal acts as the expected signal and is used to identify the incoming BOC PRN signal 204. In some embodiments, the local replica 216 of the BOC PRN signal has zero time offset, zero frequency offset, and infinite bandwidth when the BOC PRN correlation 214 between the BOC PRN signal 204 and the local replica 216 of the BOC PRN signal is formed.

The BOC PRN correlation 214 between the BOC PRN signal 204 and the local replica 216 indicates the degree of similarity or relationship between them. An amplitude or correlation coefficient of the correlation quantifies the strength of the similarity between the two signals. For example, a high correlation coefficient (close to +1) suggests a strong positive similarity, meaning that as one signal increases, the other tends to increase as well. Conversely, a correlation coefficient close to −1 indicates a strong negative similarity, where one signal tends to decrease as the other increases. A correlation coefficient close to 0 suggests little to no similarity between the signals. Signals with high positive correlation often exhibit similar shapes or patterns over time. For example, if two signals are positively correlated, they can show similar fluctuations, peaks, or troughs at corresponding points in time. Correlation analysis can also reveal any time lag or delay between the two signals. For example, a peak in cross-correlation at a specific lag indicates that one signal is shifted relative to the other. When the BOC PRN correlation 214 is maximized, the presence and identity of the BOC PRN signal 204 can be accurately verified.

In some embodiments where the BOC PRN signal 204 is filtered via the low-pass filter 208, the filtered BOC PRN signal 210 is used to form the BOC PRN correlation 214 instead of the BOC PRN signal 204. Note that in such instances, the local replica 216 of the BOC PRN signal is not filtered by the low-pass filter 208.

The storage subsystem 202 holds instructions executable by the logic subsystem 200 to instantiate a center peak extractor 218. The center peak extractor 218 is configured to extract a center peak 220 from the BOC PRN correlation 214 between the BOC PRN signal 204 (or filtered BOC PRN signal 210) and the local replica 216 of the BOC PRN signal. The center peak 220 is defined as the as highest peak at the center of the BOC PRN correlation 214.

In some embodiments, the center peak extractor 218 is configured to determine other information used for signal tracking from the BOC PRN correlation 214. In some embodiments, the center peak extractor 218 is configured to determine an effective carrier power 221 of the BOC PRN signal 204 based at least on an amplitude of the center peak 220. In some embodiments, the center peak extractor 218 is configured to determine a tracking error 223 of the BOC PRN signal 204 based at least on a peak width of the center peak 220. Such information can be used to adjust parameters of local replica signals to track a BOC PRN signal.

Further, the center peak extractor 218 is configured to generate a center peak local replica signal 222 based at least on the center peak 220 extracted from the BOC PRN correlation 214 between the BOC PRN signal 204 (or filtered BOC PRN signal 210) and the local replica 216 of the BOC PRN signal. The center peak extractor 218 can be configured to generate the center peak local replica signal 222 using different approaches in different embodiments. In one embodiment, the center peak extractor 218 is configured to de-convolute, in a time domain, the center peak 220 of the BOC PRN correlation between the BOC PRN signal 204 (or the filtered BOC PRN signal 210) and the local replica 216 of the BOC PRN signal to generate the center peak local replica signal 222. De-convolution in time domain can be a complex process for several reasons. As one example, real-world signals are often contaminated with noise. De-convolving a signal from its convolutional output can amplify the noise, leading to an unstable or inaccurate result. As another example, in the time domain, signals are represented as functions of time, and convolution corresponds to a mathematical operation involving integration over time. This operation can be complex to reverse accurately, especially if the convolution operation involves signals with specific characteristics such as sharp edges or discontinuities, such as the peaks of the BOC PRN correlation 214. As yet another example, implementing de-convolution algorithms can be computationally challenging and can constrain the computational resources of the satellite receiver 100, in some instances.

In some embodiments, to avoid the challenges of performing de-convolution in the time domain, the center peak extractor 218 can be configured to perform operations in a frequency domain to generate the center peak local replica signal 222. In one example, the center peak extractor 218 is configured to convert the center peak 220 of the BOC PRN correlation 214 between the BOC PRN signal 204 (or the filtered BOC PRN signal 210) and the local replica 216 of the BOC PRN signal from the time domain to the frequency domain. Further, the center peak extractor 218 is configured to convert the BOC PRN signal 204 (or the filtered BOC PRN signal 210) from the time domain to the frequency domain. In one example, such conversions are performed via Fourier transform. The center peak extractor 218 is configured to perform point-by-point division of the center peak 220 in the frequency domain and the BOC PRN signal 204 (or the filtered BOC PRN signal 210) in the frequency domain to generate the center peak local replica signal 222 in the frequency domain. The center peak extractor 218 is configured to convert the center peak local replica signal from the frequency domain to the time domain. In one example, such conversion is performed via inverse Fourier transform. The correlator 212 is configured to form a center peak correlation 224 between the BOC PRN signal 204 (or the filtered BOC PRN signal 210) received from the satellite 206 and the center peak local replica signal 222.

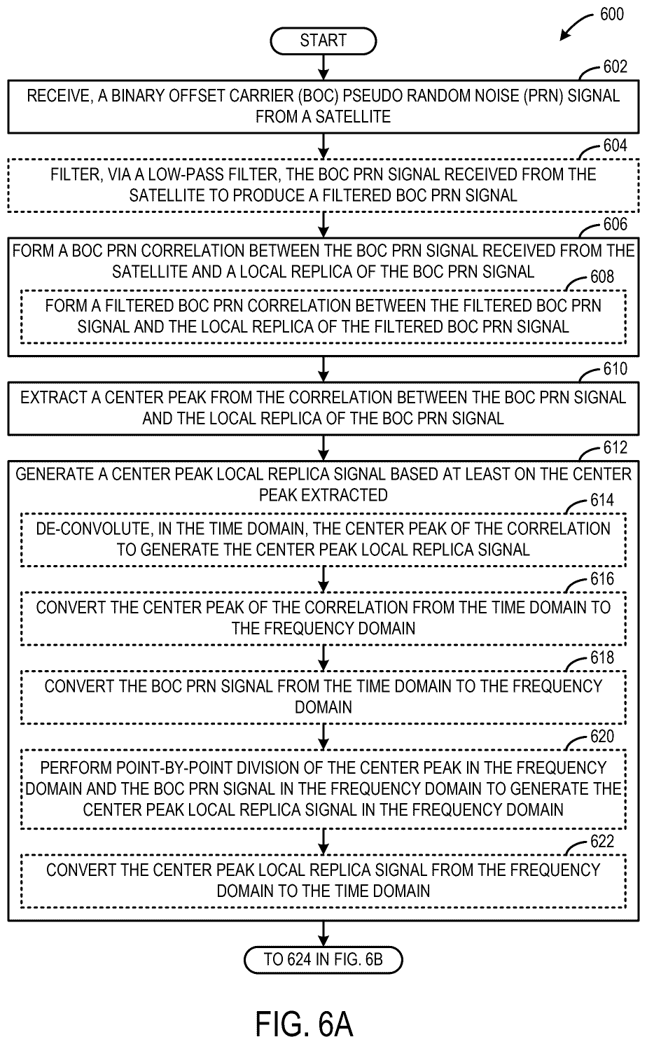

FIG. 5 shows a graph of different correlations between the BOC PRN signal 204 and different local replicas. A PRN correlation 500 (shown as a dashed line) is formed from a PRN signal that is not BOC modulated and a local replica of the PRN signal. The PRN correlation 500 looks like an isosceles triangle that peaks at Time=0. The “legs” of the peak linearly drops to a nominal value at Time=+1 and extends beyond Time=+1 fluctuating around that small value. Tracking error based on the PRN correlation 500 is related to PRN chipping rate among other parameters and it is proportional to the range/distance between the two isosceles angles at T=+1. This range is equivalent to two PRN chip duration in time. In this case, the range is two microseconds. The tracking error of this range of two microseconds (or two PRN chip duration) can be converted to its corresponding distance in meters to give tracking error in meters.

A BOC PRN correlation 502 (shown as a thick solid line) is formed from the BOC PRN signal 204 and the local replica 216 of the BOC PRN signal. For example, the BOC PRN correlation 502 may be representative of the BOC PRN correlation 214 shown in FIG. 2. Due to its binary offset subcarrier, the BPC PRN correlation 502 includes six binary offset subcarrier cycles per chip (for BOC (6,1)). The BOC PRN correlation 502 is formed by five tapered cyclical oscillations on either side of the center peak 504 at Time=0. Tracking error based on the BOC PRN correlation 502 is related to the chipping rate and is made ambiguous because of the multiple peaks formed by the binary offset carrier in the circular correlation process.

A center peak correlation 504 (shown as a thin solid line) is formed from the BOC PRN signal 204 and the center peak local replica signal 222. For example, the center peak correlation 504 may be representative of the center peak correlation 224 shown in FIG. 2. The center peak correlation 504 has a center peak at Time=0 and has the tightest isosceles angles having the tightest distance. It is apparent that this tightest distance of the center peak correlation 504 is much less than the BOC PRN correlation 502 and the PRN correlation 500.

By extracting the center peak 220 from the BOC PRN correlation 214 and using it to generate the center peak local replica signal 222 and further to form the center peak correlation 224, the offset peaks that create ambiguity in the BOC PRN correlation 214 can be eliminated. Thus, without any special design of skipping the ambiguous peaks in a generic tracking algorithm, the center peak correlation can be used to track the BOC PRN signal 204 with the least tracking error of the three correlations 500, 502, 504.

Returning to FIG. 2, the storage subsystem 202 holds instruction executable by the logic subsystem 200 to instantiate a signal tracker 226. The signal tracker 226 is configured to determine if the center peak correlation 224 between the BOC PRN signal 204 (or the filtered BOC PRN signal 210) and the center peak local replica signal 222 meet steady tracking criteria 228. The steady tracking criteria 228 is used to determine if conditions are suitable for the satellite receiver 100 to accurately retrieve navigation data 230 from the BOC PRN signal 204 received from the satellite 206.

In one example, the steady tracking criteria 228 includes comparing the center peak correlation 224 to a threshold. If the center peak correlation 224 exceeds the threshold, then the steady tracking criteria 228 is met, and the current time offset and frequency offset of the center peak replica signal 222 are used to track the BOC PRN signal 204. Note that initially the center peak local replica signal 222 can have zero time offset, zero frequency offset, and infinite bandwidth when the center peak correlation 224 is formed. The signal tracker 226 is configured to adjust the time offset and/or the frequency offset of the center peak local replica signal 222 as needed to continue to meet the steady tracking criteria 228.

Otherwise, if the center peak correlation 224 does not exceed the threshold, then the signal tracker 226 is configured to adjust at least one of the time offset and the frequency offset of the center peak local replica signal 222 based at least on a hypothesis for the correlation, and iterates searching, matching, and thresholding again to try to meet the steady tracking criteria 228.

The threshold can be set to any suitable correlation level for a given application or mission requirement. In other examples, the steady tracking criteria 228 can include other criteria. For example, the steady tracking criteria 228 can include a minimum threshold of signal strength of the BOC PRN signal, a minimum threshold of a signal-to-noise ratio (SNR) of the BOC PRN signal, a carrier-to-noise density ratio (C/NO), multipath effects, and signal coherence.

Based at least on the center peak correlation 224 meeting the steady tracking criteria, the signal tracker 226 is configured to retrieve the navigation data 230 for the satellite 206 from the BOC PRN signal 204. For example, the navigation data 230 can include ephemeris data (e.g., satellite position (in three-dimensional space), velocity, and clock offset relative to GPS time), almanac data (e.g., approximate orbital parameters of all GPS satellites, health status, and other satellite-specific information), and clock correction parameters (e.g., clock bias and drift).

The satellite receiver 100 is configured to receive BOC PRN signals from a plurality of satellites and track the BOC PRN signals according to the approach discussed herein. The satellite receiver 100 is configured to calculate a navigation solution 232 for the satellite receiver 100 based at least on navigation data 230 retrieved from the corresponding BOC PRN signals received from the plurality of satellites. In one example, the navigation solution 232 includes a position, velocity, and time of the satellite receiver 100.

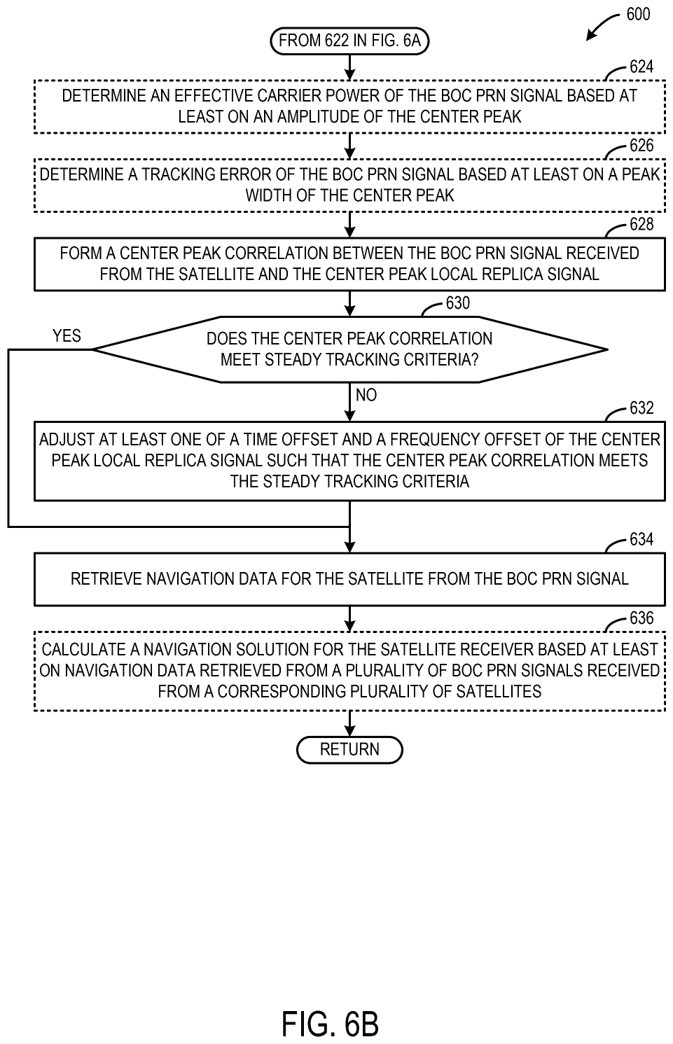

FIGS. 6A-6B show an example method 600 performed by a satellite receiver to track a BOC PRN signal with improved accuracy relative to a conventional tracking approach. For example, the method 600 can be performed by the satellite receiver 100 shown in FIGS. 1 and 2, or another suitable satellite receiver. Note that method steps shown in dotted lines may be optional in some embodiments.

In FIG. 6A, at 602 the method 600 includes receiving a BOC PRN signal from a satellite.

In some embodiments, at 604, the method 600 can include filtering, via a low-pass filter, the BOC PRN signal received from the satellite to produce a filtered BOC PRN signal. The filtered BOC PRN signal can have a higher SNR relative to the BOC PRN signal, which may help to increase tracking accuracy.

At 606, the method 600 includes forming a BOC PRN correlation between the BOC PRN signal received from the satellite and a local replica of the BOC PRN signal. In some embodiments where the received BOC PRN signal is filtered, at 608, the method 600 may include forming a filtered BOC PRN correlation between the filtered BOC PRN signal and the local replica of the BOC PRN signal.

At 610, the method 600 includes extracting a center peak from the BOC PRN correlation.

At 612, the method 600 includes generating a center peak local replica signal based at least on the center peak extracted from the BOC PRN correlation.

In some embodiments, at 614, the method 600 may include de-convoluting, in the time domain, the center peak of the BOC PRN correlation to generate the center peak local replica signal.

Alternatively, in some embodiments, the center peak local replica signal can be generated in the frequency domain. In particular, at 616, the method 600 may include converting the center peak of the BOC PRN correlation from the time domain to the frequency domain. At 618, the method 600 may include converting the BOC PRN signal from the time domain to the frequency domain. At 620, the method 600 may include performing point-by-point division of the center peak in the frequency domain and the BOC PRN signal in the frequency domain to generate the center peak local replica signal in the frequency domain. At 622, the method 600 may include converting the center peak local replica signal from the frequency domain to the time domain.

In FIG. 6B, in some embodiments, at 624, the method 600 may include determining an effective carrier power of the BOC PRN signal based at least on an amplitude of the center peak. In some embodiments, at 626, the method 600 may include determining a tracking error of the BOC PRN signal based at least on a peak width of the center peak. This information can be used to adjust parameters of local replica signals to track a BOC PRN signal.

At 628, the method 600 includes forming a center peak correlation between the BOC PRN signal received from the satellite and the center peak local replica signal. In embodiments where the received BOC PRN signal is filtered, the center peak correlation may be formed between the filtered BOC PRN signal and the center peak local replica signal.

At 630, the method 600 includes determining if the center peak correlation meets steady tracking criteria. In one example, the steady tracking criteria includes comparing the correlation to a threshold. If the correlation exceeds the threshold, then the steady tracking criteria is met, and the method moves to 634. Otherwise, if the correlation does not exceed the threshold, then the steady tracking criteria is not met, and the method 600 moves to 632.

At 632, the method 600 includes adjusting at least one of a time offset and a frequency offset of the center peak local replica signal such that the center peak correlation meets the steady tracking criteria.

At 634, the method 600 includes retrieving navigation data for the satellite from the BOC PRN signal.

In some embodiments, at 636, the method 600 may include calculating a navigation solution for the satellite receiver based at least on navigation data retrieved from a plurality of BOC PRN signals received from a corresponding plurality of satellites.

By tracking a BOC PRN signal received from a satellite based at least on a center peak correlation between the BOC PRN signal and a center peak local replica signal generated for the BOC PRN signal, ambiguity and tracking errors are reduced relative to a conventional tracking approach. This is because the center peak local replica signal only includes the center peak of the initial correlation and the other side-peaks generated from the BOC modulation scheme are not generated out of the center peak local replica signal.

The methods and processes described herein can be tied to a computing system of one or more computing devices. In particular, such methods and processes can be implemented as an executable computer-application program, a network-accessible computing service, an application-programming interface (API), a library, or a combination of the above and/or other compute resources.

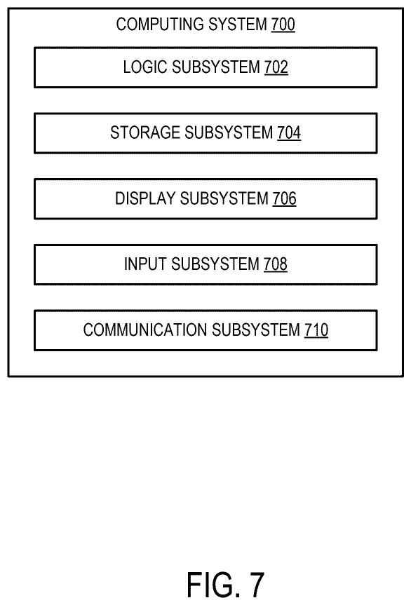

FIG. 7 schematically shows a simplified representation of a computing system 700 configured to provide any to all of the compute functionality described herein. Computing system 700 can take the form of one or more satellites, satellite receivers, personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices. For example, the computing system 700 can be representative of the satellite receiver 100 and the plurality of satellites 102A, 102B, 102C, 102D of FIG. 1, and the satellite receiver 100 shown in FIG. 2.

Computing system 700 includes a logic subsystem 702 and a storage subsystem 704. Computing system 700 can optionally include a display subsystem 706, input subsystem 708, communication subsystem 710, and/or other subsystems not shown in FIG. 7.

Logic subsystem 702 includes one or more physical devices configured to execute instructions. For example, the logic subsystem can be configured to execute instructions that are part of one or more applications, services, or other logical constructs. The logic subsystem can include one or more hardware processors configured to execute software instructions. Additionally, or alternatively, the logic subsystem can include one or more hardware or firmware devices configured to execute hardware or firmware instructions. Processors of the logic subsystem can be single-core or multi-core, and the instructions executed thereon can be configured for sequential, parallel, and/or distributed processing. Individual components of the logic subsystem optionally can be distributed among two or more separate devices, which can be remotely located and/or configured for coordinated processing. Aspects of the logic subsystem can be virtualized and executed by remotely-accessible, networked computing devices configured in a cloud-computing configuration.

Storage subsystem 704 includes one or more physical devices configured to temporarily and/or permanently hold computer information such as data and instructions executable by the logic subsystem. When the storage subsystem includes two or more devices, the devices can be collocated and/or remotely located. Storage subsystem 704 can include volatile, nonvolatile, dynamic, static, read/write, read-only, random-access, sequential-access, location-addressable, file-addressable, and/or content-addressable devices. Storage subsystem 704 can include removable and/or built-in devices. When the logic subsystem executes instructions, the state of storage subsystem 704 can be transformed—e.g., to hold different data.

Aspects of logic subsystem 702 and storage subsystem 704 can be integrated together into one or more hardware-logic components. Such hardware-logic components can include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem can cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine can be instantiated by a single computing device, or a machine can include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality can optionally be saved as one or more unexecuted modules on one or more suitable storage devices.

The terms “module,” “program,” and “engine” can be used to describe an aspect of computing system 700 typically implemented in software by a processor to perform a particular function using portions of volatile memory, which function involves transformative processing that specially configures the processor to perform the function. For example, in FIG. 2, the correlator 212, the center peak extractor 218, and the signal tracker 226 may be representative modules. Thus, a module, program, or engine can be instantiated via the logic subsystem 702 executing instructions held by storage subsystem 704. It will be understood that different modules, programs, and/or engines can be instantiated from the same application, service, code block, object, library, routine, API, function, etc. Likewise, the same module, program, and/or engine can be instantiated by different applications, services, code blocks, objects, routines, APIs, functions, etc. The terms “module,” “program,” and “engine” can encompass individual or groups of executable files, data files, libraries, drivers, scripts, database records, etc.

When included, display subsystem 706 can be used to present a visual representation of data held by storage subsystem 704. This visual representation can take the form of a graphical user interface (GUI). Display subsystem 706 can include one or more display devices utilizing virtually any type of technology. In some implementations, display subsystem can include one or more virtual-, augmented-, or mixed reality displays.

When included, input subsystem 708 can comprise or interface with one or more input devices. An input device can include a sensor device or a user input device. Examples of user input devices include a keyboard, mouse, touch screen, or game controller. In some embodiments, the input subsystem can comprise or interface with selected natural user input (NUI) componentry. Such componentry can be integrated or peripheral, and the transduction and/or processing of input actions can be handled on- or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 710 can be configured to communicatively couple computing system 700 with one or more other computing devices. Communication subsystem 710 can include wired and/or wireless communication devices compatible with one or more different communication protocols. The communication subsystem can be configured for communication via personal-, local- and/or wide-area networks.

Further, the disclosure comprises configurations according to the following clauses.

In an example, a method for tracking a binary offset carrier (BOC) pseudo random noise (PRN) signal performed by a satellite receiver comprises receiving a BOC PRN signal from a satellite, forming a BOC PRN correlation between the BOC PRN signal received from the satellite and a local replica of the BOC PRN signal, extracting a center peak from the BOC PRN correlation, generating a center peak local replica signal based at least on the center peak extracted from the BOC PRN correlation, forming a center peak correlation between the BOC PRN signal received from the satellite and the center peak local replica signal, and based at least on the center peak correlation meeting steady tracking criteria, retrieving navigation data for the satellite from the BOC PRN signal. In this example and/or other examples, the method may further comprise de-convoluting, in a time domain, the center peak of the BOC PRN correlation to generate the center peak local replica signal. In this example and/or other examples, the method may further comprise converting the center peak of the BOC PRN correlation from the time domain to a frequency domain, converting the BOC PRN signal from the time domain to the frequency domain, performing point-by-point division of the center peak in the frequency domain and the BOC PRN signal in the frequency domain to generate the center peak local replica signal in the frequency domain, and converting the center peak local replica signal from the frequency domain to the time domain. In this example and/or other examples, the method may further comprise determining an effective carrier power of the BOC PRN signal based at least on an amplitude of the center peak. In this example and/or other examples, the method may further comprise determining a tracking error of the BOC PRN signal based at least on a peak width of the center peak. In this example and/or other examples, the local replica of the BOC PRN signal may have zero time offset, zero frequency offset, and infinite bandwidth when the BOC PRN correlation is formed. In this example and/or other examples, the method may further comprise filtering, via a low-pass filter, the BOC PRN signal received from the satellite to produce a filtered BOC PRN signal, wherein a filtered BOC PRN correlation is formed between the filtered BOC PRN signal and the local replica of the BOC PRN signal, and wherein the center peak correlation is formed between the filtered BOC PRN signal and the center peak local replica signal. In this example and/or other examples, the method may further comprise based at least on the center peak correlation not meeting the steady tracking criteria, adjusting at least one of a time offset and a frequency offset of the center peak local replica signal such that the center peak correlation meets the steady tracking criteria. In this example and/or other examples, the satellite can be one of a plurality of satellites being tracked by the satellite receiver, and the method may further comprise calculating a navigation solution for the satellite receiver based at least on navigation data retrieved from corresponding BOC PRN signals received from the plurality of satellites.

In another example, a satellite receiver comprises a logic subsystem, a storage subsystem holding instructions executable by the logic subsystem to receive a binary offset carrier (BOC) pseudo random noise (PRN) signal from a satellite, form a BOC PRN correlation between the BOC PRN signal received from the satellite and a local replica of the BOC PRN signal, extract a center peak from the BOC PRN correlation, generate a center peak local replica signal based at least on the center peak extracted from the BOC PRN correlation, form a center peak correlation between the BOC PRN signal received from the satellite and the center peak local replica signal, and based at least on the center peak correlation meeting steady tracking criteria, retrieve navigation data for the satellite from the BOC PRN signal. In this example and/or other examples, the storage subsystem can hold instructions executable by the logic subsystem to de-convolute, in a time domain, the center peak of the BOC PRN correlation to generate the center peak local replica signal. In this example and/or other examples, the storage subsystem can hold instructions executable by the logic subsystem to convert the center peak of the BOC PRN correlation from the time domain to a frequency domain, convert the BOC PRN signal from the time domain to the frequency domain, perform point-by-point division of the center peak in the frequency domain and the BOC PRN signal in the frequency domain to generate the center peak local replica signal in the frequency domain, and convert the center peak local replica signal from the frequency domain to the time domain. In this example and/or other examples, the storage subsystem can hold instructions executable by the logic subsystem to determine an effective carrier power of the BOC PRN signal based at least on an amplitude of the center peak. In this example and/or other examples, the storage subsystem can hold instructions executable by the logic subsystem to determine a tracking error of the BOC PRN signal based at least on a peak width of the center peak. In this example and/or other examples, the local replica of the BOC PRN signal may have zero time offset, zero frequency offset, and infinite bandwidth when the BOC PRN correlation is formed. In this example and/or other examples, the storage subsystem can hold instructions executable by the logic subsystem to filter, via a low-pass filter, the BOC PRN signal received from the satellite to produce a filtered BOC PRN signal, wherein a filtered BOC PRN correlation may be formed between the filtered BOC PRN signal and the local replica of the BOC PRN signal, and wherein the center peak correlation may be formed between the filtered BOC PRN signal and the center peak local replica signal. In this example and/or other examples, the storage subsystem can hold instructions executable by the logic subsystem to adjust at least one of a time offset and a frequency offset of the center peak local replica signal such that the center peak correlation meets the steady tracking criteria based at least on the center peak correlation not meeting the steady tracking criteria. In this example and/or other examples, the satellite may be one of a plurality of satellites being tracked by the satellite receiver, and the storage subsystem can hold instructions executable by the logic subsystem to calculate a navigation solution for the satellite receiver based at least on navigation data retrieved from corresponding BOC PRN signals received from the plurality of satellites.

In yet another example, a method for tracking a binary offset carrier (BOC) pseudo random noise (PRN) signal performed by a satellite receiver comprises receiving a BOC PRN signal from a satellite, filtering, via a low-pass filter, the BOC PRN signal received from the satellite to produce a filtered BOC PRN signal, forming a BOC PRN correlation between the filtered BOC PRN signal and a local replica of the BOC PRN signal, extracting a center peak from the BOC PRN correlation, converting the center peak of the BOC PRN correlation from a time domain to a frequency domain, converting the filtered BOC PRN signal from the time domain to the frequency domain, performing point-by-point division of the center peak in the frequency domain and the filtered BOC PRN signal in the frequency domain to generate a center peak local replica signal in the frequency domain, converting the center peak local replica signal from the frequency domain to the time domain, forming a center peak correlation between the filtered BOC PRN signal and the center peak local replica signal, and based at least on the center peak correlation meeting steady tracking criteria, retrieving navigation data for the satellite from the BOC PRN signal. In this example and/or other examples, the satellite may be one of a plurality of satellites being tracked by the satellite receiver, and the method may further comprise calculating a navigation solution for the satellite receiver based at least on navigation data retrieved from corresponding BOC PRN signals received from the plurality of satellites.

It will be understood that the configurations and/or approaches described herein are exemplary in nature, and that these specific embodiments or examples are not to be considered in a limiting sense, because numerous variations are possible. The specific routines or methods described herein can represent one or more of any number of processing strategies. As such, various acts illustrated and/or described can be performed in the sequence illustrated and/or described, in other sequences, in parallel, or omitted. Likewise, the order of the above-described processes can be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for tracking a binary offset carrier (BOC) pseudo random noise (PRN) signal performed by a satellite receiver, the method comprising:
receiving a BOC PRN signal from a satellite;
forming a BOC PRN correlation between the BOC PRN signal received from the satellite and a local replica of the BOC PRN signal;
extracting a center peak from the BOC PRN correlation;
generating a center peak local replica signal based at least on the center peak extracted from the BOC PRN correlation;
forming a center peak correlation between the BOC PRN signal received from the satellite and the center peak local replica signal; and
based at least on the center peak correlation meeting steady tracking criteria, retrieving navigation data for the satellite from the BOC PRN signal.

2. The method of claim 1, further comprising:
de-convoluting, in a time domain, the center peak of the BOC PRN correlation to generate the center peak local replica signal.

3. The method of claim 1, further comprising:
converting the center peak of the BOC PRN correlation from the time domain to a frequency domain;
converting the BOC PRN signal from the time domain to the frequency domain;
performing point-by-point division of the center peak in the frequency domain and the BOC PRN signal in the frequency domain to generate the center peak local replica signal in the frequency domain; and
converting the center peak local replica signal from the frequency domain to the time domain.

4. The method of claim 1, further comprising:
determining an effective carrier power of the BOC PRN signal based at least on an amplitude of the center peak.

5. The method of claim 1, further comprising:
determining a tracking error of the BOC PRN signal based at least on a peak width of the center peak.

6. The method of claim 1, wherein the local replica of the BOC PRN signal has zero time offset, zero frequency offset, and infinite bandwidth when the BOC PRN correlation is formed.

7. The method of claim 1, further comprising:
filtering, via a low-pass filter, the BOC PRN signal received from the satellite to produce a filtered BOC PRN signal, wherein a filtered BOC PRN correlation is formed between the filtered BOC PRN signal and the local replica of the BOC PRN signal, and wherein the center peak correlation is formed between the filtered BOC PRN signal and the center peak local replica signal.

8. The method of claim 1, further comprising:
based at least on the center peak correlation not meeting the steady tracking criteria, adjusting at least one of a time offset and a frequency offset of the center peak local replica signal such that the center peak correlation meets the steady tracking criteria.

9. The method of claim 1, wherein the satellite is one of a plurality of satellites being tracked by the satellite receiver, and wherein the method further comprises:
calculating a navigation solution for the satellite receiver based at least on navigation data retrieved from corresponding BOC PRN signals received from the plurality of satellites.

10. A satellite receiver comprising:
a logic subsystem;
a storage subsystem holding instructions executable by the logic subsystem to:
receive a binary offset carrier (BOC) pseudo random noise (PRN) signal from a satellite;
form a BOC PRN correlation between the BOC PRN signal received from the satellite and a local replica of the BOC PRN signal;
extract a center peak from the BOC PRN correlation;
generate a center peak local replica signal based at least on the center peak extracted from the BOC PRN correlation;
form a center peak correlation between the BOC PRN signal received from the satellite and the center peak local replica signal; and
based at least on the center peak correlation meeting steady tracking criteria, retrieve navigation data for the satellite from the BOC PRN signal.

11. The satellite receiver of claim 10, wherein the storage subsystem holds instructions executable by the logic subsystem to:
de-convolute, in a time domain, the center peak of the BOC PRN correlation to generate the center peak local replica signal.

12. The satellite receiver of claim 10, wherein the storage subsystem holds instructions executable by the logic subsystem to:
convert the center peak of the BOC PRN correlation from the time domain to a frequency domain;
convert the BOC PRN signal from the time domain to the frequency domain;
perform point-by-point division of the center peak in the frequency domain and the BOC PRN signal in the frequency domain to generate the center peak local replica signal in the frequency domain; and
convert the center peak local replica signal from the frequency domain to the time domain.

13. The satellite receiver of claim 10, wherein the storage subsystem holds instructions executable by the logic subsystem to:
determine an effective carrier power of the BOC PRN signal based at least on an amplitude of the center peak.

14. The satellite receiver of claim 10, wherein the storage subsystem holds instructions executable by the logic subsystem to:
determine a tracking error of the BOC PRN signal based at least on a peak width of the center peak.

15. The satellite receiver of claim 10, wherein the local replica of the BOC PRN signal has zero time offset, zero frequency offset, and infinite bandwidth when the BOC PRN correlation is formed.

16. The satellite receiver of claim 10, wherein the storage subsystem holds instructions executable by the logic subsystem to:
filter, via a low-pass filter, the BOC PRN signal received from the satellite to produce a filtered BOC PRN signal, wherein a filtered BOC PRN correlation is formed between the filtered BOC PRN signal and the local replica of the BOC PRN signal, and wherein the center peak correlation is formed between the filtered BOC PRN signal and the center peak local replica signal.

17. The satellite receiver of claim 10, wherein the storage subsystem holds instructions executable by the logic subsystem to:
based at least on the center peak correlation not meeting the steady tracking criteria, adjust at least one of a time offset and a frequency offset of the center peak local replica signal such that the center peak correlation meets the steady tracking criteria.

18. The satellite receiver of claim 10, wherein the satellite is one of a plurality of satellites being tracked by the satellite receiver, and wherein the storage subsystem holds instructions executable by the logic subsystem to:
calculate a navigation solution for the satellite receiver based at least on navigation data retrieved from corresponding BOC PRN signals received from the plurality of satellites.

19. A method for tracking a binary offset carrier (BOC) pseudo random noise (PRN) signal performed by a satellite receiver, the method comprising:
receiving a BOC PRN signal from a satellite;
filtering, via a low-pass filter, the BOC PRN signal received from the satellite to produce a filtered BOC PRN signal;
forming a BOC PRN correlation between the filtered BOC PRN signal and a local replica of the BOC PRN signal;
extracting a center peak from the BOC PRN correlation;
converting the center peak of the BOC PRN correlation from a time domain to a frequency domain;
converting the filtered BOC PRN signal from the time domain to the frequency domain;
performing point-by-point division of the center peak in the frequency domain and the filtered BOC PRN signal in the frequency domain to generate a center peak local replica signal in the frequency domain;
converting the center peak local replica signal from the frequency domain to the time domain;
forming a center peak correlation between the filtered BOC PRN signal and the center peak local replica signal; and
based at least on the center peak correlation meeting steady tracking criteria, retrieving navigation data for the satellite from the BOC PRN signal.

20. The method of claim 19, wherein the satellite is one of a plurality of satellites being tracked by the satellite receiver, and wherein the method further comprises:
calculating a navigation solution for the satellite receiver based at least on navigation data retrieved from corresponding BOC PRN signals received from the plurality of satellites.
